(19) United States
(12) Patent Application Publication
(10) Pub. No.: US 2008/0108391 A1
(43) Pub. Date: May 8, 2008

(54) PROCESS FOR TRANSFERRING MULTIMEDIA DATA

(76) Inventors: Jean-Marie Vau, Paris (FR); Thierry Lebihen, Bourg La Reine (FR)

Correspondence Address: Frank Pincelli;Patent Legal Staff, Eastman Kodak Company, 343 State Street, Rochester, NY, 14650-2201, US

(21) Appl. No.: 11/854,073

(22) Filed: Sep. 12, 2007

(30) Foreign Application Priority Data
Nov. 3, 2006 (FR) 0609597

(51) Int. Cl. H04B 1/38

(52) U.S. Cl. 455/566

(57) ABSTRACT

The invention relates to a process of data transfer between donor equipment (10d) and at least one receiver equipment (10r), each comprising short distance communication means (18d, 18r), the donor equipment also being provided with a display screen (12d) and being linked to a first data container (30d), the process comprising:
the display on the screen (12d) of the donor equipment (10d) of an icon (14d) having semantic content representative of the multimedia data (52) to be transferred, previously selected on the donor equipment, and,
   in response to approaching the donor and receiver equipments;
the transfer (36) from the donor equipment towards the receiver equipment of data (32) corresponding to the icon and availability data (34) giving access to the multimedia data selected in the first data container.

### CROSS-REFERENCE TO RELATED APPLICATION

This application claims priority to French Patent Application No. 0609597, filed on Nov. 3, 2006, which is incorporated herein by reference in its entirety.

### FIELD OF THE INVENTION

The present invention relates to a process for transferring multimedia data between electronic equipment and in particular between portable electronic equipment. “Multimedia” data means—image data, audio data, text data, and software data or again any combination of these data. The invention especially has applications in the user-to-user exchange of images and/or audio. The invention can also be used for the transfer of multimedia data to and from fixed equipment.

### BACKGROUND OF THE INVENTION

In the field of multimedia digital data exchange, there is a high number of different vectors. Among others, there are optical, magnetic or semi-conductor data equipment supports; radio broadcasting; telephone networks; public and private networks like Internet or Intranets; near radio transmission like Bluetooth or Wi-Fi; RFID inductive local transmission; barcodes and visual codes.

One can associate with each data vector a number of technical characteristics that, according to the nature of the data to be exchanged, and according to their use, can constitute either advantages or disadvantages.

These often mutually incompatible characteristics are, for example, pass band, ease of access, capacity to target a large number of users, capacity to make data exchanges secure, range of the exchange, lifespan of the exchanged data, their quality in terms of fineness resolution or spatial frequency, and, above all, user-friendliness of the exchange.

### SUMMARY OF THE INVENTION

In the field of user-to-user exchanges, for example, a phonecam (mobile phone with built-in image sensor) to another phonecam, or to similar mobile equipment, three exchange aspects are important for their decisive influence on the user-friendliness of data exchanges. These are: a) the intuitive identification by users of the content of the exchange; b) putting the equipment into communication properly speaking, and finally; c) the data transfer time.

Intuitive identification of the content of the exchange is essential for the digital data exchange to be intuitively understood as an ordinary exchange dealing with material goods or an exchange of whatever favors based on the mutual trust of the exchange players. The appearance of the dual character arising between the digital data and the multimedia content that they represent is of a kind to disturb for an inexperienced user and raise doubt as to the security of the multimedia objects. This is especially the case when the data form part of the user's private area or the user at least assimilates the data to this area.

Putting equipment into communication assumes the opening of a communication channel and thus a selection of electronic addresses. This can be done by means of an interactive interface, or a control interface of the equipment. The multiplication of the number of commands required before achieving the effective data transfer rapidly becomes an obstacle to the communication. A high number of commands is seen as a tedious task for the user.

As regards the data transfer time, the use of low range communication modes generally provides the opportunity of broad pass bands and enables high transfer rates. However, this reality risks concealing the fact that, for very low range communication modes, the equipment in communication must be kept at a close distance for the whole time of the data exchange. Thus a data transfer time of a few or tens of seconds, very short in fact, is seen as a waiting time during which the user must keep their equipment close to the comparable equipment. These waiting times, although short, can rapidly become unacceptable.

The constraints related to the data exchange can be illustrated in particular for image data exchanges. Digital image data exchanges, if they are to be user-friendly, must offer the same facility as the hand-to-hand exchange of photographic prints.

The hand-to-hand exchange of photographic prints, apart from its immediacy, enables the photo's content to be seen directly, and the recipient of the photo is selected by the simple gesture of handing it over.

An embodiment of the present invention is a digital data transfer process tending to prevent the above-mentioned difficulties and to answer the needs of transparency, user-friendliness, and speed of exchange.

Another embodiment of the present invention guarantees the security and lifespan of digital information.

Another embodiment of the present invention provides different levels of security capable of protecting the confidentiality of a data exchange.

To achieve these objects, embodiments of the present invention relate more precisely to a process of data transfer between donor equipment and at least one receiver equipment, each comprising short-distance communication means, the donor equipment also being provided with a display screen and being linked to a first data container, the process comprising:
the display on the screen of the donor equipment of an icon having semantic content representative of the multimedia data to be transferred previously selected on the donor equipment, and,
   in response to approaching the donor and receiver equipments;
the transfer from the donor equipment towards the receiver equipment of data corresponding to the icon and availability data giving access to the multimedia data selected in the first data container.

Short-distance communication means denotes a means capable of transmitting digital data with a short range, typically of about a few to some tens of centimetres. These means can be optical, inductive or radio. These are preferably means usually called NFC (Near Field Communication). Thanks to their very short range, the user of the donor equipment can thus physically select one or more receiver equipments present in their environment. The user just has to approach the donor equipment towards the selected receiver equipments and keep it away from any other equipment present by a distance greater than the range. Pairing and communication of availability data are thus only made with the selected equipment. Selection can thus be made in certain cases from the receiver equipment, for example by approaching or not the receiver equipment towards the fixed donor equipment.

While brief, the short range of the communication means provides a first security against unwanted data transfers.

It is worth saying that the words “donor” and “receiver” functionally designate the equipment in the transfer process but do not presume the exclusive or not design of the equipment for its function. In particular, the same equipment can be both donor and receiver, according to the direction of data transfer wanted by the users. Thus, electronic equipment intended to be used selectively to transmit or receive multimedia data, can have a control for selecting the incoming or outgoing direction of the data transfer.

The first data container is a container housing all or part of the digital data of the donor equipment. The container can be a remote container, such as the server of a data storage provider, or simply a memory internal to the donor equipment. The connection between the donor equipment and the data container can be a connection of internal cabling, external cabling, a wireless connection, or a connection by communication network, for example. It can be permanent or intermittent. The donor equipment can be linked to several containers of separate data.

The display of an icon representative of the selected multimedia data has the function of identifying the multimedia data for which access is liable to be allowed. Identification takes place because of the icon's semantic content. When the selected data are image data, the semantic content is rendered, for example, by an icon in the form of a low-resolution thumbnail image, tiling of images formed of a plurality of thumbnails, or again an animated sequence of images in succession. The icon can also be shown in the form of a logo, or more simply text formed of one or more words that are descriptive or suggestive of the data. The thumbnail, logo or text can of course apply to other multimedia content so long as they have a meaning in relation to this content and are capable of informing the user accordingly.

The choice of low-resolution thumbnail to represent image data is particularly advantageous in so far as the display of the thumbnail, and especially its' display on a small-sized screen, avoids showing the user the duality between the data and the icon representing the data.

Approaching the donor and receiver equipments causes the opening of a communication channel and a double data transfer. What is transmitted is not only the retrieval data, i.e. data enabling the receiver equipment to access the offered data, but also the data of the representative icon.

On data reception, this enables the icon to be displayed on the screen of the receiver equipment, as required. In the special case of transferring an image, and if the icon is simply the representation of a low-resolution version of the image data, the transfer of just the data corresponding to the icon simulates the transfer of the selected data. This simulation can occur almost instantaneously, both because of the short-range communication and the broad pass band, and because of the lower digital weight of the icon compared with the digital weight of the selected data.

The apparent result for users is that the image displayed on the screen of the donor equipment “passes” instantaneously to the screen of the receiver equipment as soon as the equipments are approached.

The actual transfer of the selected data can at this moment be postponed, or even avoided in certain cases. Starting the transfer of the selected data can be automatic, in response to reception of the retrieval data or be subject to an explicit command made on one of the donor or receiver equipments by a user.

For example, it is possible to allow the user of the receiver equipment the time to get an idea of the multimedia content on offer from the donor equipment, by the display of the icon alone, and to then decide whether the transfer properly speaking of the selected data is wanted or not.

Transfer of the selected data can be operated either towards the receiver equipment, or towards a second remote data container to which the receiver equipment is linked. In the first case, it may be considered that the receiver equipment also constitutes the second data container.

Following the example of the abovementioned first data container, the second container can be built-in or remote, and the receiver equipment can be connected to the second data container permanently or intermittently. In this respect, the first and second data containers can correspond to different account numbers of the same service provider. The provider is, for example, a storage and image data distribution provider.

The storage of image data in one or more containers has the advantage of not linking any physical data loss by the donor and receiver equipments and the loss of the data that they convey.

The retrieval data are data such as account number, pointer, electronic address, access tree, developed link or any combination of these. In general, the retrieval data comprise all the information required for the receiver equipment to access the selected data from the first data container and download them, as required.

The security of the exchanged data can be improved by adding additional identification data, such as a transaction code, to the retrieval data.

The retrieval data can comprise a transaction code supplied to the remote container. In this case, data recovery is subject to a check of the transaction code. The transaction code can be linked to the selected data so as to reserve access only for the selected data during a data transfer transaction.

Other characteristics and advantages of the invention will appear in the following description, with reference to the figures in the appended drawings. This description is given purely as an illustration and is not limiting.

### BRIEF DESCRIPTION OF THE DRAWINGS

FIG. 1 schematically illustrates a first step of a data transfer process according to the invention consisting in pairing donor equipment and receiver equipment; and

FIG. 2 illustrates, also schematically, various data exchanges capable of resulting from pairing.

### DETAILED DESCRIPTION OF THE INVENTION

To simplify, the following description relates to two identical mobile electronic equipments marked by references 10d and 10r and exchanging image data between each other. Further the exchange is described in a single direction from equipment 10d towards equipment 10r, the indices r and d specifying the receiver or donor function of the equipments.

However, it should be noted that a data exchange process according to the invention can be implemented to exchange other types of multimedia data, for exchanging between a larger number of equipment, for exchanging data from mobile equipment towards fixed equipment, from fixed equipment towards one or more mobile equipments, and that the donor and receiver character of the equipment can be switched over.

In particular, fixed equipment capable of benefiting from the process can be an interactive terminal offering users the possibility of uploading or collecting multimedia data, for their reproduction, or for their transfer to data media. These are, for example, a terminal of a data storage provider and/or of a provider producing photographic prints from digital images.

A first step of the process consists in displaying on a screen 12d of the donor equipment a representing icon 14d, i.e. an icon that represents the data capable of being transferred. This is an icon having semantic content, i.e. content that enables a user to identify the corresponding data.

In the case of image data, an image corresponding to the full resolution data or to downgraded resolution data can be displayed as an icon. The icon can also include a text such as “Jean-Marie birthday 2006” that allows a user to identify a set of digital images entered for a particular occasion.

The data to be transferred can first be selected on the donor equipment 10d. Selection of the data to be transferred on the donor equipment does not presume the existence or not of these data in the donor equipment. Just the presence or creation of the representing icon data and the retrieval data is sufficient. The selection can be performed by means of an interface 16d of the equipment, possibly using the intermediate display of a suitable menu or tree.

After the data selection, the donor equipment can be put into an operating mode enabling the data to be proposed to comparable equipment. This operating mode can be selected manually or automatically.

In this operating mode of short-distance communication means 18d, for example the above-mentioned NFC, is on standby for interaction with a comparable means 18r of receiver equipment. The simple act of approaching the equipments to a distance of less than or equal to the range of the short-distance communication means causes the opening of a communication channel and the mutual identification of the equipments.

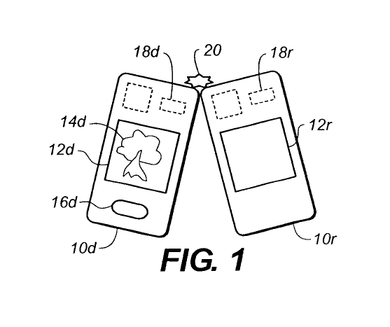

The communication channel thus made is represented symbolically with reference 20 in FIG. 1. It enables the transfer from the donor equipment towards the receiver equipment both of data corresponding to the displayed representing icon 14d, and of availability data of the selected data.

It should be stated that the data corresponding to the representing icon that are transferred from the donor equipment towards the receiver equipment are not necessarily identical to the data used for the previous display of the icon on the screen of the donor equipment. This is the case, for example, when the high-resolution image data selected for the transfer are available in the donor equipment. High-resolution data can be used to display a high-resolution image on the display screen of the donor equipment, and enable this high-resolution image to be used as the icon representing the data. However, in this case, the data corresponding to the icon that are transmitted to the receiver equipment by the short-range channel are preferably lower resolution image data, but relative to the same image. Lower resolution data can first be available in the donor equipment but can also be computed from high-resolution data.

However, this situation is only a special case. Preferably, the data used to display the representing icon on the donor equipment and the corresponding data transmitted to the receiver equipment are identical and have a digital weight less than the multimedia data selected for the transfer properly speaking.

Following receipt of the data corresponding to the icon, an icon, similar to that displayed on the donor equipment can also be displayed on the screen 12r of the receiver equipment. It should be noted that on receipt of the data relating to the icon and the retrieval data, the transfer properly speaking of the selected multimedia data is not yet performed. It is simply made possible from the receiver equipment.

Transfer of the selected data can take place automatically or in response to a specific command entered on the receiver equipment. This transfer preferably uses a communication means of the receiver equipment different than the short-distance communication means.

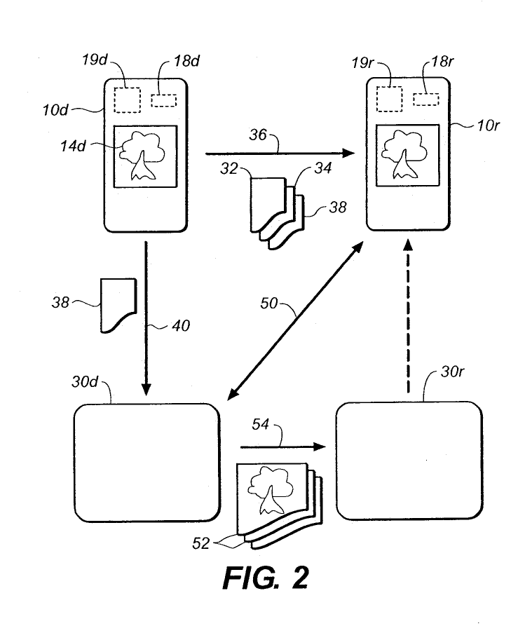

Transfer of the selected multimedia data is described in more detail with reference to FIG. 2.

FIG. 2 shows electronic donor and receiver equipments 10d and 10r similar to those of FIG. 1. It also shows first and second data containers 30d and 30r linked to the donor and receiver equipments respectively. The data containers can possibly form an integral part of the electronic equipment. However, these are preferably remote containers to which the electronic equipments 10d and 10r can be linked by long-range communication means. The containers can correspond, for example, to memory spaces reserved on one or more remote servers to which the electronic equipments, 10d and 10r, can be connected by the Internet.

When the electronic equipment in question is fixed equipment, such as an interactive terminal, the container can have in part a local memory and in part a remote memory.

FIG. 2 illustrates the transfer of image data selected on the donor equipment 10d. As described previously, and in response to approaching the equipments, low-resolution image data 32 and availability data 34 are transmitted from the donor equipment 10d towards the receiver equipment 10r. This data transmission, shown by an arrow 36 takes place through short-range communication means at the moment when the equipments are approached. Its duration is short and the digital weight of the exchanged data is low. Receipt of the low-resolution image data 32 enables the display on the screen 12r of the receiver equipment of an icon 14r with the same semantic content as the icon 14d previously displayed on the screen of the donor equipment 12d.

Transfer of the data 36 is performed when the equipments come into contact or when they are at a distance of a few to some tens of centimetres.

Transmission 34 of the retrieval data can be completed by security data in the form of a transaction code 38 specific to each interaction between the donor equipment and receiver equipment. In this case, the transaction code 38 is also transmitted towards the server hosting the first data container. This check, especially suited when the data container is remote, is symbolized in a simple way by an arrow 40 pointing to the data container 30d.

A double arrow 50 symbolizes communication made between the receiver equipment 10r and the first data container 30d. According to the physical distance between the receiver equipment 10r and the container 30d, the exchange can take place through a public or private communication network or through a local wireless communication network 19r. These means are separate from the short-range communication means 18d, 18r.

The communication 50 is made on the initiative of the receiver equipment, automatically or not, by using the retrieval data, to recover the selected multimedia data. The communication 50 can also include the transmission from the receiver equipment 10r towards the first data container 30d of a transaction code. This is for example the transaction code 38 supplied by the donor equipment with the retrieval data 34.

A server or computer unit used to manage the first data container can then be planned to compare the transaction codes coming from the donor and receiver equipments, to check whether these codes are identical and correspond correctly with the requested multimedia data. Following these checks, the data can be recovered. They are transmitted either from the first container towards the receiver equipment, which corresponds to the double arrow 50, or from the first container 30d towards a second container 30r that is a container hosting the data of the receiver equipment 10r. The transfer of multimedia data 52 towards the container 30r hosting the multimedia data of the receiver equipment is symbolized by an arrow 54. The transfer can be direct if the two containers are hosted in the same server or in connected servers. By default, the transfer takes place through a public network, such as the Internet, or through a private network.

After the multimedia data 52 have reached the second data container, they can be routed or not from the second container towards the receiver equipment, or towards other equipment according to a procedure specific to the receiver equipment.

It should be noted that the communication 50 with the data container, as well as data recovery, can be direct or not. In particular, the communication 50 and recovery of the data can also be performed by remote equipment, such as a server to which the retrieval data will have been transmitted by the receiver equipment 10r. This is for example a data management server of the second container 10r.

In this case, it is considered that starting the data transfer corresponds to the transmission of the retrieval data from the receiver equipment 10r towards the equipment in charge of the recovery of the selected data properly speaking. The recovery can be delayed in time from receipt of the retrieval data.

Thanks to the transfer process described, the data transfer apparent to the user is that which causes the display of the icon representing the data. At the time of an image transfer and if the icon is a downgraded resolution version of the image, the user can thus instantaneously profit from the image proposed by the donor equipment and possibly share it with another receiver according to the process described here.

The actual data transfer takes place in a way that is not apparent to the user. It can be delayed in time and can possibly require long downloading times without this appearing as a problem for the user.

The invention has been described in detail with particular reference to certain preferred embodiments thereof, but it will be understood that variations and modifications can be effected within the spirit and scope of the invention.

### PARTS LIST

10d Donor equipment
10r Receiver equipment
12d, 12r Screen
14d Icon
16d Interface
18d, 18r Short distance communication means
19r, 19d Wireless communication means
20 Communication channel
30d, 30r Data containers
32 Low resolution image data
34 Retrieval data
36 Data transmission
38 Transaction code
40 Transaction code transmission
50 Communication
52 Multimedia data
54 Data transfer

What is claimed is:

1. A data transfer method between a donor equipment and at least one receiver equipment, each comprising short distance communication means, the donor equipment also being provided with a display screen and being linked to a first data container, the method comprising:
displaying on the screen of the donor equipment an icon having semantic content representative of multimedia data to be transferred, the icon previously selected on the donor equipment, and,
in response to bringing closer the donor and receiver equipment;
transferring from the donor equipment to the receiver equipment data corresponding to the icon and retrieval data giving access to the multimedia data selected in the first data container.

2. The method according to claim 1, further comprising, following the transfer step, displaying the representing icon on the display screen of the receiver equipment.

3. The method according to claim 1, wherein the multimedia data comprises data selected from among images, audio, text, software data or a combination of such data.

4. The method according to claim 1, further comprising, following the transfer step, retrieving data selected in the first data container, the retrieving being triggered by at least one of the donor and receiver equipment.

5. The method according to claim 4, wherein a recovery of the data comprises transferring the multimedia data selected from the first data container to a second data container linked to the receiver equipment.

6. The method according to claim 5, wherein the first and second data containers correspond to account numbers of a service provider.

7. The method according to claim 1, wherein the icon is selected from among a low-resolution thumbnail image, tiled images corresponding to a plurality of thumbnails, an animated sequence, a logo and text.

8. The method according to claim 1, wherein the retrieval data comprises at least one from among an account number, pointer, transaction number, address, access tree and developed link.

9. The method according to claim 1 wherein the first and/or second data container is a remote container, the donor equipment being connected to the first data container through a communication network.

10. The method according to claim 4 wherein the first data container is a remote container, in which the retrieval data includes a transaction code supplied to the remote container and in which data recovery is subject to a check of the transaction code.

11. Apparatus comprising:
a donor equipment and at least one receiver equipment, each comprising short distance communication means, the donor equipment also comprising a display screen and linked to a first data container;
an icon selected on the donor equipment displayed on the display screen of the donor equipment, the icon having semantic content representative of multimedia data to be transferred; and
means for transferring from the donor equipment to the receiver equipment data corresponding to the icon and retrieval data giving access to the multimedia data selected in the first data container, in response to bringing closer the donor and receiver equipment.

12. The apparatus according to claim 11, wherein the display screen further comprises the icon after a transfer.

13. The apparatus according to claim 11, wherein the multimedia data comprises data selected from among images, audio, text, software or a combination of such data.

14. The apparatus according to claim 11, wherein selected data is retrieved from the first container triggered by at least one of the donor and receiver equipment, following a transfer.

15. The apparatus according to claim 14, further comprising a second data container linked to the receiver equipment, wherein a recovery of the data comprises a transfer of the multimedia data selected from the first data container to the second data container.

16. The apparatus according to claim 15, wherein the first and second data containers correspond to account numbers of a service provider.

17. The apparatus according to claim 11, wherein the icon is selected from among a low-resolution thumbnail image, tiled images corresponding to a plurality of thumbnails, an animated sequence, a logo and text.

18. The apparatus according to claim 11, wherein the retrieval data comprises at least one from among an account number, pointer, transaction number, address, access tree and developed link.

19. The apparatus according to claim 1 wherein the first data container is a remote container, and wherein the donor equipment is connected to the first data container through a communication network.

20. The apparatus according to claim 14 wherein the first data container is a remote container, the retrieval data includes a transaction code supplied to the remote container, and wherein data recovery is subject to a check of the transaction code.
